(19) United States
(12) Patent Application Publication
(10) Pub. No.: US 2005/0071271 A1
(43) Pub. Date: Mar. 31, 2005

(54) System and method for providing information regarding an identity's true availability

(75) Inventor: Mark Bernard Hettish, Cary, NC (US)

Correspondence Address: Siemens Corporation;Attn: Elsa Keller, Legal Administrator, Intellectual Property Department, 170 Wood Avenue South, Iselin, NJ, 08830, US

(73) Assignee: Siemens Information and Communication Networks, Inc.

(21) Appl. No.: 10/673,846

(22) Filed: Sep. 29, 2003

(51) Int. Cl. H04K 1/00

(52) U.S. Cl. 705/50

(57) ABSTRACT

Embodiments provide a system, methods, apparatus, means, and computer program code for determining and providing information regarding an identity's availability.

### FIELD

The present invention relates to a method, system, means and computer code for providing information regarding an identity's availability.

### BACKGROUND

A person in a multi-media or multi-channel communications system may have or use multiple devices, such as a telephone, personal digital assistant (PDA), computer, etc. Thus, the person may be represented by or associated with the different types of devices. A second person may want to contact the first person via email, instant message communication, telephone call, etc. The ability of the second person to contact or communicate with the first person may be limited by the availability of the device(s) chosen by the second person and/or the availability of the first person. For example, if the first person currently is using his or her telephone, the second person may not be able to contact the first person via telephone. However, the second person may be able to contact the first person via an email message sent to the first person's computer. In addition, if the first person is on vacation or out of the office, the second person may not be able to reach the first person via a telephone or computer located at the first person's office, but may be able to reach the first person via cellular telephone. As another example, if the first person is “busy,” the second person might not be able to reach the first person at all, even if all of the devices associated with the first person are currently available. If the second person can determine the true availability of the first person, the second person may be able to make better choices regarding how to communicate with the first person. However, the first person also may want his or her true availability to depend on other factors, such as who is trying to contact the first person, time of day, personal schedule, etc.

As such, there is a need for a system, method, apparatus, means, and computer program code for providing information regarding an identity's availability and for allowing the identity to establish one or more rules regarding the identity's availability.

### SUMMARY

Embodiments provide a system, method, apparatus, means, and computer program code for determining and/or providing information regarding an identity's true availability and for allowing an identity to establish one or more rules regarding the identity's availability. In some embodiments an identity may be or include an individual person/user or a group of people/users.

Each identity may have multiple devices associated with it. For example, a person may have various devices (e.g., cellular telephone, computer, personal digital assistant) that support voice calls and/or instant messaging. If the person is on a voice call, then the person's media availability with regard to devices that support voice calls may be set to unavailable. However, the person still may be able to participate in communications involving instant messages. Other people may receive or retrieve the information regarding the person's device availabilities via different mechanisms and attempt to contact the person via a media channel that is available.

In some embodiments an identity may be or include an individual person or a group of people. Each identity may have an identity context associated with it. Along with an identify context is an implied state of availability. For example, an identity context for an identity could be a state of “in a meeting”, “on vacation,” “in the office,” “out of the office,” “roaming,” “offline,” “online,” “in transit,” “mobile,” etc. Thus, the identity context describes an implied availability of the identity, but not its true availability.

An identity may have one or more devices associated with it. Each device may have an associated device context. Context for a device may describe the work or non-work state, and/or the availability or non-availability state, that the device is in. For example, the person's office telephone may be busy, set to “do not disturb,” automatic call forwarding, offline, etc.

True availability of an identity may be calculated or limited by availability of devices associated with the identity. In addition, the identity's true availability also may be qualified or established by one or more rules created or used by the entity, a system administer, or other party, device or application. Thus, in some embodiments, an identity's true availability may depend on factors such as, for example, the time of day, day of week, device context of availability, the identity of a caller, etc. Identities attempting to contact another identity may be provided with information that allows them to determine the identity's true availability on one or more devices or communication channels.

Additional advantages and novel features shall be set forth in part in the description that follows, and in part will become apparent to those skilled in the art upon examination of the following or may be learned by the practice of the invention.

According to some embodiments, a method may include determining an availability rule associated with an identity; determining an availability of the identity based, at least in part, on the availability rule; and providing data indicative of the availability of the identity. Other embodiments may include means, systems, computer code, etc. for implementing some or all of the elements of the methods described herein.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE FIGURES

The accompanying drawings, which are incorporated in and form a part of the specification, illustrate embodiments of the invention.

FIG. 1 is a block diagram of a system according to some embodiments;

FIG. 2 is another block diagram of the system according to some embodiments;

FIG. 3 is a flowchart of a method in accordance with some embodiments;

FIG. 4 is a representative example of an interface providing information regarding media availability for an identity;

FIG. 5 is another representative example of an interface providing information regarding media availability for an identity;

FIG. 6 is another representative example of an interface providing information regarding media availability for an identity; and

FIG. 7 is a block diagram of a server that may implement one or more of the components of FIG. 1 and/or one or more elements of the methods described herein.

### DESCRIPTION OF SPECIFIC EMBODIMENTS

There is a market opportunity for systems, means, computer code, and methods that allow and enable information regarding true availability of an first identity (e.g., an individual person/user) to be determined and/or provided to one or more other identities who may wish to contact the first identity. In some embodiments, information regarding the true availability for the first identity may be displayed via an interface on a user device (e.g., computer, PDA, cellular telephone) so that a complete picture of availability for the first identity is obtained.

In some embodiments an identity may be or include an individual person/user or a group of people/user. Each identity may have an associated identity context. An identity context for the identity could be a state of “in meeting.” “on vacation,” “in the office,” “out of the office,” “roaming,” “offline,” “online,” “unknown,” “on business trip,” “in transit,” “mobile,” etc. Thus, the identify context describes the availability of the identity.

An identity context then allows an identity to have an overall state that describes the work or non-work state that the identity is in and in itself provides an implied availability of sorts. For example, an identity context state of “offline” for an identity may indicate that the identity is generically offline for any number of reasons. Thus, a potential communicator with this identity should not expect to get any live contact. As another example, an identity context state of “online” for an identity may indicate that the identity is generically online. Thus, a potential communicator with this identity could expect some chance of communicating with the identity by voice, instant messaging, etc. An identity context state of “in meeting” for an identity may indicate that the identity is not at his or her desk, but elsewhere attending a meeting. Thus, a potential communicator with this identity might expect to be able to get voice or instant messaging contact only in urgent situations. An identity context state of “in the office” for an identity may indicate that the identity is in his or her office. Thus, potential communicator may be able to reach the identity via voice or instant message communication with devices in the identity's office or via an email message sent to a device in the identity's office. An identity context state of “roaming” for an identity may indicate that the identity is in the office, but not necessarily at his or her desk. However, the identity may be available via a cellular telephone or other mobile device associated with the identity. An identity context state of “do not disturb” or “DND” for an identity may indicate that the identity is not accepting telephone calls, instant message communications, and/or other forms of communication. An identity context state of “in transit” for an identity may indicate that the identity is currently out of the office, away from home, and/or mobile on the way to a destination. This state also may imply that the identity has a specific mobile device (e.g., cellular telephone, PDA) and can be contacted via one or both of those devices. An identity context state of “mobile” for an identity may indicate that the identity is working or located at a more permanent mobile environment. This context may imply that identity may be reachable via a portable or mobile device or a communication device associated with the permanent mobile environment. But in all cases, it must be recognized the identity context is merely an implied availability and cannot be presented as the true availability of the identity.

In some embodiments, different applications may be used to set, monitor or change an identity context for an identity. For example, a calendar program, telephone user interface, graphical user interface, plug-in, etc. may allow or enable an identity to set or change an identity context for the identity manually or automatically.

An identity may have one or more associated devices. For example, a person may have an associated office telephone, a home telephone, an office telephone, a cellular telephone, computer, personal digital assistant (PDA), etc. Each device may have an associated device context. For example, the person's office telephone may be busy, set to “do not disturb,” automatic call forwarding, offline, etc. Context for a device may describe the work or non-work state, and/or the availability or non-availability state, that the device is in. In some embodiments, potential device contexts may include “available,” “non-available,” “busy,” “away,” “unknown,” “partially available” (e.g., a device may be “busy” on a voice channel but available on an instant messaging channel), “be right back,” “present,” not present,” etc. In some embodiments, different applications may be used to set, monitor or change a device context for a device. For example, software operating on a computer may allow an identity to indicate manually or automatically that the computer is unavailable for email, instant messaging, file transfer or other communications at the current time, at a specific later time, during a time range, etc. As another example, a wireless and instant messaging capable PDA may be considered as having a device context as “available” by a presence and availability service when the PDA is online and a device context of “unavailable” by the presence and availability service when the PDA is offline. But in all cases, it must be noted that device contexts of a user's devices are not an indication of true availability of the identity.

In some embodiments, the true availability of an identity may be calculated or limited by the availability of devices associated with the identity. For example, an identity's cellular telephone may not be available at certain locations. As another example, the identity may be unable or unwilling to receive a telephone call while the identity is participating in a meeting. However, since an identity often uses more than one device, availability of the identity at or via one of the devices may not reflect the true availability of the identity. For example, suppose the identity has a workstation based “soft” telephone client application and a SIP (Session Initiation Protocol) client application operating. If the soft telephone client application is busy, the identity still may be contactable in other ways. For example, if the soft client is busy on a voice call, the soft client still may be able to accept contact in other ways such as, for example, instant messaging. If the soft client is busy on a voice call or with an instant message communication, the identity still may be able to accept or conduct voice calls or instant messaging sessions. But in all cases, it must be noted that device availability of a user's devices is not an indication of true availability of the identity.

In addition to the above, an identity's availability may be qualified or established by one or more rules, filters, policies, conventions, etc. (herein referred to as “rules”) created or used by the identity, a system administrator, or other party, device or application. In some embodiments, an identity may establish or use one or more rules such that that the identity's availability may depend on factors such as, for example, the time of day, day of week, device context, personal schedule, system rules or schedule, the identity of a caller, etc. For example, a first identity may be “in the office” and the first identity may be available to accept both telephone calls and instant messages via devices associated with the first identity. In general, a second identity or a third identity may be able to see that the first identity is both in the office and available for communication via telephone and instant messaging. However, the first identity may establish one or more rules that provide that the first identity is not available to accept instant messages between 1:00 pm and 3:00 pm and that telephone calls from the third identity always should be sent to voice mail. These rules may be unknown to the second and third identities. If the second identity attempts to send an instant message at 2:00 pm to the first identity, the desired contact will not occur in accordance with the rules. If the third identity attempts to call the first identity, the third identity will automatically be sent to voice mail in accordance with the rules established by the first identity. The second and third identities may be able to receive, access, and/or view information regarding the availability of the first identity so they may know how they may be able to contact the first identity and/or the availability of the first identity.

As one can see, true availability cannot be ascertained by identity context, device context or device context, but only by a combination of these and other data points, in conjunction with a set of rules. Because such data points may include transient information such as time of day and relationship to the other user, true availability can only be presented by the execution of the rules at a specific point in time. For example, all things being the same, the true availability may change from 12:00 pm vs. 2:00 pm.

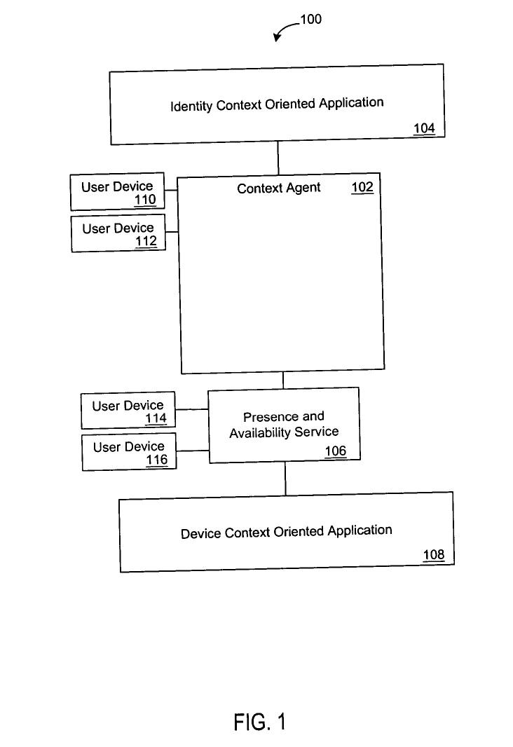

Now referring to FIG. 1, an exemplary system 100 is illustrated according to some embodiments. The system 100 includes a context agent 102 that may be connected to or in communication with an identity context oriented application 104 and a presence and availability service 106. The system 100 also may include a device context oriented application 108 connected to or in communication with the presence and availability service 106. In some embodiments, not all of the components illustrated in FIG. 1 will be needed or used.

In some embodiments, one or more user devices, such as the user devices 110, 112, may be connected to or in communication with the context agent 102. Similarly, user devices, such as user devices 114, 116, may be connected to or in communication with the presence and availability service 106. In some embodiments, a user device may be or include such things as telephones, cellular telephones, PDAs, computers, etc. For example, the user devices 114, 116, may be personal computers implementing the Windows XP™ operating system and the Windows Messenger™ instant messenger system. In addition, the user devices 114, 116 may include telephony and other multimedia messaging capability using, for example, peripheral cameras, Webcams, microphones and speakers (not shown) or peripheral telephony handsets, such as the Optipoint™ handset available from Siemens Information and Communication Networks.

In some embodiments, the system 100 may include other hardware and/or software components (e.g., gateways, proxy servers, registration servers, presence servers, redirect servers, databases, applications, telephone systems, communication networks), such as, for example, hardware and software used to support a SIP or other protocol based infrastructure for the system 100 and allow registration of SIP devices in the system 100.

In some embodiments, the context agent 102 may monitor the identity context of one or more identities and/or the device context of one or more devices. In some embodiments, the context agent 102 may provide or include an application interface that supports identity context, device context, device presence, and/or other functions. Applications may monitor, access and/or query the context agent 102 for identity context and/or device context information. Applications may also modify the identity context and/or device context information via the context agent 102.

In some embodiments, the context agent 102 may maintain or have access to information regarding the devices associated with one or more identities, the media capabilities for one or more devices associated with one or more identities, etc. For example, the context agent 102 may determine or be able to find out that a SIP telephone associated with an identity has both voice and instant messaging capabilities. In some cases, other applications or devices may provide media capability information to the context agent 102 and/or the context agent 102 may be able to retrieve the media capability information from a device (e.g., a registration server) or application.

In some embodiments, the context agent 102 may provide information to the identity context oriented application 104 upon request, periodically, or in accordance with some other plan or procedure. In addition, in some embodiments, the context agent 102 may provide information regarding device context. For example, an application may query the context agent 102 to monitor or determine the device context of one or more devices. In some embodiments, an application may set or request a change for either an identity context and/or a device context. For example, an application that sets an identity context for an identity to “in meeting” may set the device context for the identity's desk telephone to “offline” for both voicemail and instant messaging.

In some embodiments, the context agent 102 may be able to receive, retrieve, or otherwise obtain information regarding an identity and/or a device associated with the identity, such as calendar information, schedule information, location information, configuration information, context information, etc.

The context agent 102 may be implemented in hardware and/or software operating on one or more servers, computer systems, host or mainframe computers, workstations, etc. In some embodiments the context agent 102 may be operating on some or all of the same device(s) as other components in the system 100.

In some embodiments, the identity context oriented application 104 may be or include an application that uses, collects, refers to, etc. information regarding the identity context of one or more identities. For example, an identity context oriented application may be or include software that allows identities to provide information regarding their availability, location, etc. In some embodiments, a user device, server, host or mainframe computer, workstation, etc. may include an identity context oriented application or have one operating or residing on it. The identity context oriented application 104 may be implemented in hardware and/or software operating on one or more servers, computer systems, host or mainframe computers, workstations, etc. In some embodiments the identity context oriented application 104 may be operating on some or all of the same device(s) as other components in the system 100.

The presence and availability service 106 may be or include an application that monitors the presence and availability of devices. That is, the presence and availability service 106 monitors the device context of one or devices. In some embodiments, one or more of the devices may be associated with the identities whose context is used or monitored by the identity context oriented application 104. The presence and availability service 106 may be implemented in software operating on one or more servers, computer systems, host or mainframe computers, workstations, etc. In some embodiments the presence and availability service 106 may be operating on some or all of the same device(s) as other components in the system 100.

In some embodiments, the presence and availability service 106 may be or include an application that communicates with or is connected to one or more registered devices (e.g., devices 114, 116) and that allows devices to register with the system 100 or helps facilitate their registration, etc. For example, in a SIP environment, the devices 114, 116 may be registered with the system 100 and may show up or be described in registration databases as being assigned to particular identities. The context agent 102 may register with the presence and availability service 106 and receive device context and/or other information from the presence and availability service regarding the devices 114, 116 and/or other devices.

In some embodiments, the presence and availability service 106 may provide device context information to the device context oriented application 108 upon request, periodically, or in accordance with some other plan or procedure. In some embodiments, the presence and availability service may implement an instant messaging system. For example, the instant messaging system may be embodied as Microsoft Windows Messenger™ software or other instant messaging system.

The device context oriented application 108 may be or include an application that uses, collects, refers to, etc. information regarding the device context of one or more device (e.g., the user device 114). For example, a device context oriented application may be or include software that allows identities to provide or request information regarding the availability of devices associated with the identities, etc. In some embodiments, a user device, server, host or mainframe computer, workstation, etc. may include a device context oriented application or have one operating or residing on it. The device context oriented application 108 may be implemented in hardware and/or software operating on one or more servers, computer systems, host or mainframe computers, workstations, etc. In some embodiments the device context oriented application 108 may be operating on some or all of the same device(s) as other components in the system 100.

The terms “identity context,” “device context,” “context agent,” “presence and availability service,” “identity context oriented application,” and “device context oriented application” are used herein merely for purposes of convenience and ease of explanation and no specific limitations are intended or implied by the use of these terms herein.

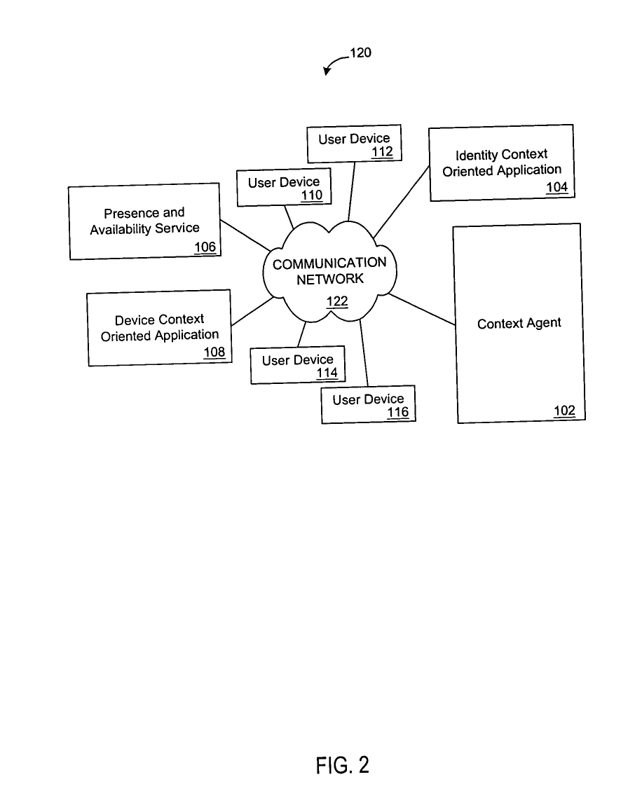

In some embodiments, one or more of the components of the system 100 may be connected or in communication with each other via a communication network. For example, now referring to FIG. 2, a system 120 including the components of the system 100 is illustrated, wherein some or all of the components are in direct or indirect communication via a network 122. The network 122 may be or include the Internet, the World Wide Web, a local area network, or some other public or private computer, cable, telephone, client/server, peer-to-peer, or communications network or intranet. In some embodiments, a communications network also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL connections, etc. Moreover, as used herein, communications include those enabled by wired or wireless technology. In some embodiments, some or all of the network 122 may be implemented using a TCP/IP network and may implement voice or multimedia over IP using, for example, the Session Initiation Protocol (SIP).

Process Description

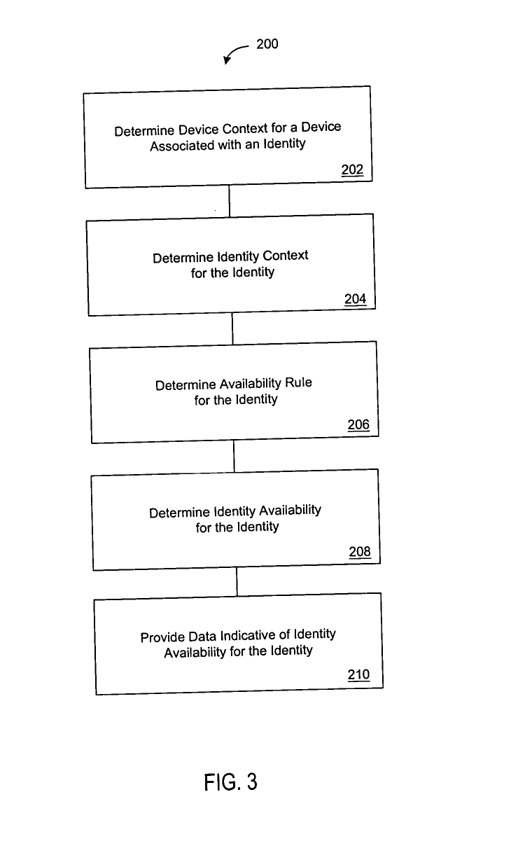

Reference is now made to FIG. 3, where a flow chart 200 is shown which represents the operation of a first embodiment. The particular arrangement of elements in the flow chart 200 is not meant to imply a fixed order to the elements; embodiments can be practiced in any order that is practicable. In some embodiments, the context agent 102 may implement the method 200.

Processing begins at 202 during which device contexts for one or more devices associated with an identity are determined. For example, the context agent 102 may determine the device contexts for multiple devices (e.g., a cellular telephone, a PDA, a computer) associated with an identity. As previously discussed above, the context agent 102 may monitor such device context(s) and/or receive information regarding such device context(s). The context agent 102 may monitor, have, or be able to obtain information regarding devices associated with one or more identities. In some embodiments, the method 200 may include the context agent 102 receiving a request to provide information or data regarding availability for an identity or device. In some embodiments of the method 200, 202 might not be used or implemented.

During 204, identity context for the identity is determined. As previously discussed above, the context agent 102 may monitor, have, or be able to obtain information regarding identity contexts for one or more identities. In some embodiments of the method 200, 204 might not be used or implemented.

During 206, one or more availability rules for the identity are determined. In some embodiments, availability rules may be established by the identity. For example, the identity may establish rules that dictate when the identity is available and can be contacted by telephone call, instant message, etc. (e.g., an identity may not want to receive or accept a telephone call after 6:00 pm and may implement a rule that routes such a call to an operator or to voicemail, thereby indicating the identity's unavailability via telephone call after 6:00 pm). As another example, the identity may establish rules that govern when or how he or she is available and/or can be contacted by other identities (e.g., the identity may be available at all times via telephone to other identities on a VIP list, but unavailable to all other identities via telephone after 6:00 pm). As another example, the identity may establish one or more rules that govern how or when an identity can be contacted based on the identity context of the identity (e.g., all calls with go to voice mail if the identity's identity context is “in a meeting”). In a further example, the identity may establish a rule that is based on device context (e.g., if the identity is engaged in an instant message session via a device, than all calls will go directly to voice mail unless the caller is listed on a list established by the identity).

In some embodiments, an availability rule regarding one or more identities may be established by a system administrator, device, or application. For example, a system administrator may establish a rule that provides that all calls to all identities are routed directly to an operator or voice mail after 8:00 pm. Thus, the identities are unavailable after 8:00 for contact via telephone call. As another example, the system administrator may establish a rule that provides that no instant messages will be delivered to devices associated with identities after 7:00 pm. Thus, the identities are unavailable to participate in instant message sessions after 7:00 pm.

In some embodiments, the method 200 may include allowing an identity, system administrator, device, application, etc. to establish one or more rules regarding availability of one or more identities. The context agent 102 may store rules in, or access rules from, a database or other electronic resource. In some embodiments, 206 may occur prior to 202 and/or 204. As such, depending on an availability rule being used, either 202 and/or 204 may not be needed or used in some embodiments of 200.

During 208, the availability of the identity is determined in accordance with the determinations made in 202, 204, and/or 206. It is during 208 that true availability for the identity is calculated. It should be noted that true availability is dependent upon any number of data points gathered in 202, 204, 206. In some embodiments true availability is calculated only when requested by another identity. In other embodiments it may be calculated periodically or when it is known that certain data points change.

During 210, data representing or otherwise indicative of the identity's availability is provided. For example, the context agent 102 may transmit, or otherwise provide, availability information for an identity directly or indirectly to devices (e.g., the user devices 110, 112) used by other identities that may wish to contact the identity. The devices may display the availability information via interfaces. As another example, the context agent 102 may provide the data directly or indirectly to a database server, Web site server, the identity context application oriented application 104, the device context oriented application 108, or another device or application.

In some embodiments, the data provided in 210 may indicate which or what type of devices may be used to contact a specific identity. In other embodiments, the data may not indicate such device information, but rather may indicate the type of or specific media channels in or via which the specific identity can be contacted.

In some embodiments, the data provided in 210 may only indicate an overall true availability of the user.

In some embodiments, the context agent 102 may implement the method 200 randomly, periodically, upon request, upon or after receiving an indication of a change in device context for a device, upon or after receiving an indication of a change in identity context for an identity, after registration or association of a device with the system 100, upon or after determining or receiving an indication that one identity desires to communicate with another identity, in accordance with a rule or algorithm, etc. In some embodiments, the method 200 may include the context agent 102 receiving a request for availability information regarding an identity, receiving a request for availability information regarding a device associated with an identity, receiving or otherwise determining a rule governing how availability of an identity is to be established or determined, etc.

As illustrated above, in some embodiments, a method may include determining an availability rule associated with an identity; determining an availability of the identity based, at least in part, on the availability rule; and providing data indicative of the availability of the identity. In some embodiments, the method may include one or more of the following: determining an identity context for the identity, determining a device context for one or more devices associated with the identity, receiving a request for the availability information regarding the identity and/or one or more devices associated with the identity, establishing or otherwise obtaining the availability rule, determining the identity, etc. In some embodiments, determining an availability of the identity based, at least in part, on the availability rule may include determining availability of the identity for at least two different media channels (e.g., voice call, instant messaging, email). In some embodiments, determining an availability of the identity based, at least in part, on said availability rule may include determining an availability of the identity based, at least in part, on the availability rule, an identity context for the identity, and/or a device context for one or more devices associated with the identity.

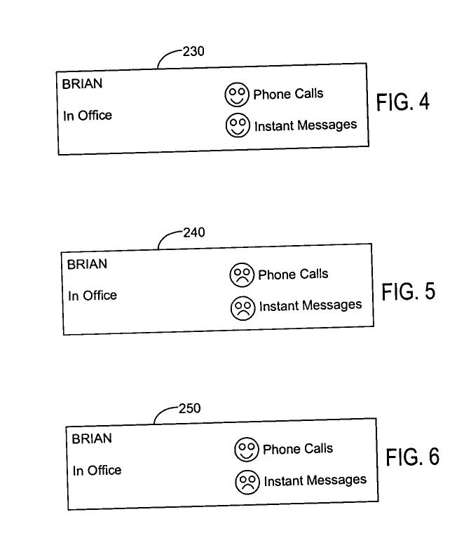

Now referring to FIG. 4 through FIG. 7, several representative interfaces are illustrated that may be provided as part of 208 or as a result of 208. Such interfaces may be included in or part of graphical user interfaces, telephony user interfaces, etc. For purposes of the examples illustrated in the figures, assume that an identity named “Brian” has various devices that support voice calls and instant message communications. Assume that Brian has an identity context of “in office” and that Brian has established a rule that indicates that he will not accept telephone calls after 6:00 pm except calls from his boss Lindsey, even if Brian is in the office. Thus, Brian is unavailable via telephone call after 6:00 pm for all identities except Lindsey. Also assume that by system policy, instant messages will not be delivered after 6:00 pm. Thus, Brian will be unavailable to participate in an instant message session after 6:00 pm.

If the time is 6:15 pm and only device context is used for Brian's availability, an identity “Dave” would see an interface 230 with respect to Brian, as indicated in FIG. 4. Both voice calls and instant messages are marked as being accepted means of contact at this point in time (i.e., Brian is available via voice call and via instant messaging at this point in time). In this example, the interface 230 does not list or indicate specific devices associated with Brian. Rather, the interface 230 provides information regarding availability of Brian via different media channels.

As a result of the rules established by Brian and the system policy, if true availability is used, Dave will be provided with the information in interface 240 illustrated in FIG. 5 that indicates that Brian is not available to Dave either by voice call or by instant message. In contrast, if true availability is used, Lindsey can be provided the true availability information for Brian as indicated in interface 250 illustrated in FIG. 6 that indicates that Brian is available by voice call to Lindsey.

Without the above true availability calculation, Dave would erroneously believe he can contact Brian.

Server

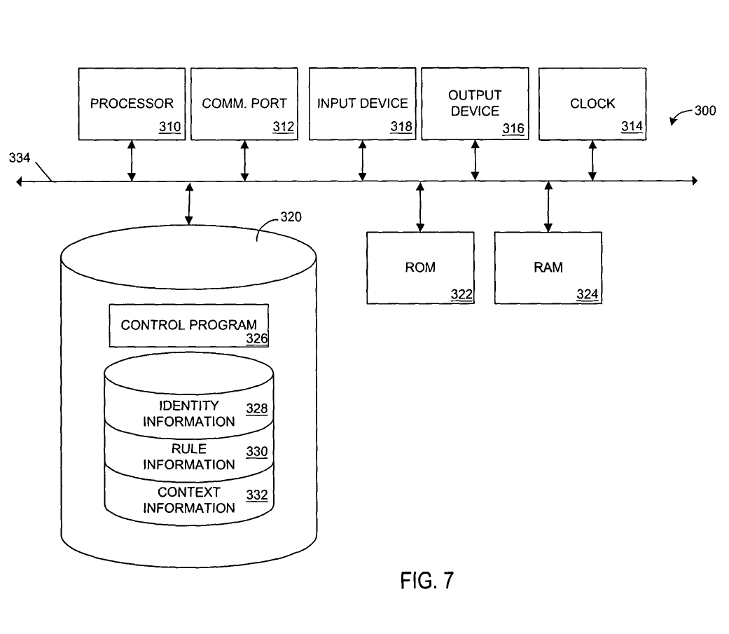

Now referring to FIG. 7, a representative block diagram of a server or controller 300 is illustrated. In some embodiments, the server 300 may include or operate an identity context oriented application, a device context oriented application, the context agent 102, and/or the presence and availability service 106. The server 300 can comprise a single device or computer, a networked set or group of devices or computers, a workstation, mainframe or host computer, etc. In some embodiments, the server 300 may implement or be adapted to implement one more elements of the methods disclosed herein.

The server 300 may include a processor, microchip, central processing unit, or computer 310 that is in communication with or otherwise uses or includes one or more communication ports 312 for communicating with user devices and/or other devices. Communication ports may include such things as local area network adapters, wireless communication devices, Bluetooth technology, etc. The server 300 also may include an internal clock element 314 to maintain an accurate time and date for the server 300, create time stamps for communications received or sent by the server 300, etc.

If desired, the server 300 may include one or more output devices 316 such as a printer, infrared or other transmitter, antenna, audio speaker, display screen or monitor, text to speech converter, etc., as well as one or more input devices 318 such as a bar code reader or other optical scanner, infrared or other receiver, antenna, magnetic stripe reader, image scanner, roller ball, touch pad, joystick, touch screen, microphone, computer keyboard, computer mouse, etc.

In addition to the above, the server 300 may include a memory or data storage device 320 to store information, software, databases, documents, communications, device drivers, etc. The memory or data storage device 320 may include an appropriate combination of magnetic, optical and/or semiconductor memory, and may include, for example, Read-Only Memory (ROM), Random Access Memory (RAM), a tape drive, flash memory, a floppy disk drive, a Zip™ disk drive, a compact disc and/or a hard disk. The server 300 also may include separate ROM 322 and RAM 324.

The processor 310 and the data storage device 320 in the server 300 each may be, for example: (i) located entirely within a single computer or other computing device; or (ii) connected to each other by a remote communication medium, such as a serial port cable, telephone line or radio frequency transceiver. In one embodiment, the server 300 may comprise one or more computers that are connected to a remote server computer for maintaining databases.

A conventional personal computer or workstation with sufficient memory and processing capability may be used as the server 300. The server 300 may be capable of high volume transaction processing, performing a significant number of mathematical calculations in processing communications and database searches. A Pentium™ microprocessor such as the Pentium III™ or IV™ microprocessor, manufactured by Intel Corporation may be used for the processor 310. Equivalent or other processors may be available from Motorola, Inc., AMD, or Sun Microsystems, Inc. The processor 310 also may comprise one or more microprocessors, computers, computer systems, etc.

Software may be resident and operating or operational on the server 300. The software may be stored on the data storage device 320 and may include a control program 326 for operating the server, databases, etc. The control program 326 may control the processor 310. The processor 310 preferably performs instructions of the control program 326, and thereby operates in accordance with the methods described in detail herein. The control program 326 may be stored in a compressed, uncompiled and/or encrypted format. The control program 326 furthermore includes program elements that may be necessary, such as an operating system, a database management system and device drivers for allowing the processor 310 to interface with peripheral devices, databases, etc. Appropriate program elements are known to those skilled in the art, and need not be described in detail herein.

The server 300 also may include or store information regarding identities, user devices, contexts, mapping tables, communications, etc. For example, information regarding one or more identities may be stored in an identity information database 328 for use by the server 300 or another device or entity. Information regarding one or more rules may be stored in a rule information database 330 for use by the server 300 or another device or entity and information regarding device and/or identity context may be stored in a context information database 332 for use by the server 300 or another device or entity. In some embodiments, some or all of one or more of the databases may be stored or mirrored remotely from the server 300.

According to some embodiments, the instructions of the control program may be read into a main memory from another computer-readable medium, such as from the ROM 322 to the RAM 324. Execution of sequences of the instructions in the control program causes the processor 310 to perform the process elements described herein. In alternative embodiments, hard-wired circuitry may be used in place of, or in combination with, software instructions for implementation of some or all of the methods described herein. Thus, embodiments are not limited to any specific combination of hardware and software.

The processor 310, communication port 312, clock 314, output device 316, input device 318, data storage device 230, ROM 322, and RAM 324 may communicate or be connected directly or indirectly in a variety of ways. For example, the processor 310, communication port 312, clock 314, output device 316, input device 318, data storage device 320, ROM 322, and RAM 324 may be connected via a bus 334.

While specific implementations and hardware/software configurations for the server 300 have been illustrated, it should be noted that other implementations and hardware configurations are possible and that no specific implementation or hardware/software configuration is needed. Thus, not all of the components illustrated in FIG. 7 may be needed for the server 300 implementing the methods disclosed herein. For example, as illustrated above, in some embodiments a system may include a processor; a communication port coupled to the processor and adapted to communicate with a plurality of network devices; and a storage device coupled to the processor and storing instructions adapted to be executed by the processor to determine an availability rule associated with an identity; determine an availability of the identity based, at least in part, on the availability rule; and provide data indicative of the availability of the identity.

The methods described herein may be embodied as a computer program developed using an object oriented language that allows the modeling of complex systems with modular objects to create abstractions that are representative of real world, physical objects and their interrelationships. However, it would be understood by one of ordinary skill in the art that the invention as described herein could be implemented in many different ways using a wide range of programming techniques as well as general-purpose hardware systems or dedicated controllers. In addition, in some embodiments, many, if not all, of the elements for the methods described above are optional or can be combined or performed in one or more alternative orders or sequences and the claims should not be construed as being limited to any particular order or sequence, unless specifically indicated.

Each of the methods described above can be performed on a single computer, computer system, microprocessor, etc. In addition, in some embodiments, two or more of the elements in each of the methods described above could be performed on two or more different computers, computer systems, microprocessors, etc., some or all of which may be locally or remotely configured. The methods can be implemented in any sort or implementation of computer software, program, sets of instructions, programming means, code, ASIC, or specially designed chips, logic gates, or other hardware structured to directly effect or implement such software, programs, sets of instructions, programming means or code. The computer software, program, sets of instructions or code can be storable, writeable, or savable on any computer usable or readable media or other program storage device or media such as a floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

Although various embodiments have been described herein, those skilled in the art will note that various substitutions may be made to those embodiments. The invention described in the above detailed description is not intended to be limited to the specific form set forth herein, but is intended to cover such alternatives, modifications and equivalents as can reasonably be included within the spirit and scope of the appended claims.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

1. A method, comprising the steps of:
determining an availability rule associated with an identity;
determining a true availability of said identity based at least in part on said availability rule; and
providing data indicative of said true availability of said identity.

2. The method of claim 1, further comprising the step of:
receiving a request for information regarding true availability of said identity.

3. The method of claim 1, wherein said step of determining said true availability of said identity based at least in part on said availability rule includes determining availability of said identity via at least two different media channels.

4. The method of claim 1, further comprising the step of:
establishing said availability rule.

5. The method of claim 1, wherein said step of providing data indicative of said availability of said interface includes displaying an interface indicative of said availability.

6. The method of claim 6, wherein said interface identifies said identity.

7. The method of claim 1, further comprising the step of:
determining said identity.

8. The method of claim 1, further comprising the step of:
determining a device context for a device associated with said identity.

9. The method of claim 8, wherein said step of determining said availability of said identity based at least in part on said availability rule includes determining an availability of said identity based at least in part on said availability rule and said device context.

10. The method of claim 8, further comprising the step of:
determining an identity context for said identity.

11. The method of claim 10, wherein said step of determining said availability of said identity based at least in part on said availability rule includes determining an availability of said identity based at least in part on said availability rule, said device context, and said identity context.

12. The method of claim 1, further comprising the step of:
determining an identity context for said identity.

13. The method of claim 12, wherein said step of determining said availability of said identity based at least in part on said availability rule includes determining an availability of said identity based at least in part on said availability rule and said identity context.

14. A system, comprising:
a context agent, said context agent adapted to determine an availability rule associated with an identity; determine a true availability of said identity based, at least in part, on said availability rule; and provide data indicative of said true availability of said identity.

15. An article of manufacture comprising:
a computer readable medium having stored thereon instructions which, when executed by a processor, cause said processor to:
determine an availability rule associated with an identity;
determine a true availability of said identity based, at least in part, on said availability rule; and
provide data indicative of said true availability of said identity.

16. A system, comprising:
a processor;
a communication port coupled to said processor and adapted to communicate with at least one device; and
a storage device coupled to said processor and storing instructions adapted to be executed by said processor to:
determine an availability rule associated with an identity;
determine an availability of said identity based, at least in part, on said availability rule; and
provide data indicative of said availability of said identity.
